(19) United States
(12) Patent Application Publication
(10) Pub. No.: US 2002/0153978 A1
(43) Pub. Date: Oct. 24, 2002

(54) Four-pole molded case circuit breaker having staggered contact depression

(76) Inventors: Randall Lee Greenberg, Granby, CT (US); Roger Neil Castonguay, Terryville, CT (US)

Correspondence Address: PATENT OPERATION, GENERAL ELECTRIC COMPANY, 41 WOODFORD AVENUE, PLAINVILLE, CT, 06062

(21) Appl. No.: 09/681,511

(22) Filed: Apr. 19, 2001

(51) Int. Cl. H01H 75/00

(52) U.S. Cl. 335/8

(57) ABSTRACT

A four-pole molded case circuit breaker is provided with connecting rods for simultaneously driving the contact arms in all four poles while at the same time allowing for a staggered contact depression in the fourth pole relative to the other three poles. A stabilizer clamp locks the connecting rods together to eliminate relative motion between the rods without interfering with the staggered contact depression. By staggering the contact depression in the fourth pole, a three-pole operating mechanism can effectively toggle a four-pole device since the load of the contact depression springs in all four poles is not seen by the operating mechanism at the same time.

### FIELD OF THE INVENTION

The present invention relates generally to a clamping apparatus for locking together rods connecting rotary contact arms in a multi-pole molded case circuit breaker. More particularly, the present invention relates to a clamping apparatus for locking together rods connecting rotary contact arms in a multi-pole molded case circuit breaker while providing clearance between the connecting rods and the rotor in the outermost fourth pole of a four-pole molded case circuit breaker, thereby modifying the contact depression in the outermost pole for effective toggling on closure.

### BACKGROUND OF THE INVENTION

It is generally well known in the art of multi-pole circuit breakers that rotary contact arms in each circuit breaker cassette are connected together with at least one rod (usually a drive rod and a support rod) to ensure their operation in unison. During quiescent operation, (i.e. when the circuit breaker contacts are closed to allow the flow of electrical current) the operating handle of an operating mechanism is in the “ON” position. To stop the current flow manually, the handle may be shifted to the “OFF” position thereby opening the electrical contacts. Upon attainment of a pre-determined condition (trip event), such as ground fault or overload, the operating mechanism of the circuit breaker will release the forces of the mechanism operating springs and release the operating handle to a tripped position between the “ON” position and the “OFF” position. Before the circuit breaker may be turned “ON”, the operating mechanism must be manually reset. This is accomplished by the operating handle placed beyond the “OFF” position against the bias of the operating mechanism springs, thereby locking the operating mechanism in position.

The circuit breaker cassettes in a multi-pole molded case circuit breaker are preferably connected together with two rods interfacing a rotary contact arm in each circuit breaker cassette; a drive rod and a support rod. In a typical three-pole molded case circuit breaker, the operating mechanism is positioned upon a cassette located symmetrically between two of the circuit breaker cassettes. Stated alternatively, if the three cassettes of a three-cassette circuit breaker are counted from left to right the operating mechanism is located on the second cassette. It is known to be desirable for circuit breakers having multiple cassettes therein that all of the cassettes trip as closely in time to one another as possible. For this purpose it has been known to provide at least one and usually two rods that extend through all of the cassettes in a particular circuit breaker. The drive rod transmits the rotational movement within one of the cassettes, due to a trip, into an impetus for the other cassettes to also trip. Because of the mechanical nature of the connection through the rods, the first and third cassettes will change position almost immediately upon change of position of the second cassette. It is also the case that any two of the cassettes will react rapidly to any one of the cassettes experiencing a trip event. This is because the drive rod is actuated by the operating mechanism and since each cassette of the three-pole circuit breaker is immediately adjacent or in contact with the operating mechanism, no torque is lost. Since the first and third cassettes are immediately adjacent the second cassette, which is mechanically connected to the operating mechanism, there is little relative movement between the rods and they function well as intended.

Four-pole circuit breakers present additional difficulties with respect to simultaneous operation of the four individual cassettes housed therein because conventionally the fourth circuit breaker cassette is added at one end of what would be the arrangement of a three-cassette circuit breaker. This is exclusive of any change in the operating mechanism. More particularly, the operating mechanism is still located on the second circuit breaker cassette. One of ordinary skill in the art thus appreciates that in a four-pole circuit breaker a single cassette is located on one side of the cassette to which the operating mechanism is attached, while two cassettes are located on the opposite side of the cassette to which the operating mechanism is attached. The rods that connect all of the cassettes in the breaker then extend further to reach the outer cassette on one side than they do on the other side. Because of relative movement between the rods and the length of the rods as it affects effective flexibility, the outer cassette may not react to movement of the operating mechanism as rapidly as would a cassette located closer to the operating mechanism. Since rapid movement of the rotor in the outer cassette is desirable, the art has sought means to speed the movement of the outer cassette.

An additional consideration in a four-pole circuit breaker, relative to a three-pole circuit breaker, is the additional work that the operating mechanism must perform in order to toggle over the mechanism linkage to drive the contact arms of all four poles to full contact depression. One skilled in the art will recognize that a toggled over mechanism is one in which the linkage arrangement of the operating mechanism has reached its design detent position to establish full contact depression. Full contact depression is recognized by one skilled in the art to be that condition where the contact arms have been driven as far as the operating mechanism can drive them while compressing contact springs to establish the design contact force.

Drive systems for four-pole devices are not limited to rotary circuit breakers, but can also be employed in such devices as conventional circuit breakers, current limiting circuit breakers, switches, and other multi-pole electrical disconnect devices. The applications that these devices are used in are vast, and include, but are not limited to, the utility, industrial, commercial, residential, and automotive industries, and may be employed in single device enclosures or multi-device electrical distribution panels.

Four-pole circuit breaker solutions have been attempted, including the provision of additional assist mechanisms added to the outer cassette, or a wide operating mechanism which is symmetrically positioned about the rotary contact assemblies. While these alternatives do enhance movement of the rotor in the outer cassette, they also increase the manufacturing cost.

Commonly assigned U.S. Pat. No. 5,287,077 (hereinafter the '077 patent) entitled “Molded Case Circuit Breaker Multi-Pole Crossbar Assembly” describes a four-pole molded case circuit breaker arrangement wherein the separation distance between the movable and stationary contacts increases from the first pole to the fourth pole. Here, the elevation of each movable contact is controlled and incrementally increased across the four poles by specifically controlling the elevation of the stop surface on the unitary multi-pole crossbar. For unitary multi-pole crossbars, the teaching of the '077 patent is applicable. However, for modular multi-cassette circuit breakers, it is desirable to have common parts with common dimensions.

Commonly assigned U.S. patent application Ser. No. 09/517,934 entitled “Contact Depression Stabilizer For 4 Pole Molded Case Circuit Breaker” filed Mar. 3, 2000, describes a four-pole molded case rotary circuit breaker arrangement wherein a drive rod and a support rod are clamped together to ensure uniform operation across all four poles. Here, the clamping arrangement minimizes the lost motion present in an unclamped arrangement, thereby enhancing the uniformity of rotary action across all four poles. However, if the contact depression is not staggered across the four poles, the operating mechanism must be capable of driving all four poles to their full contact depression simultaneously. For modular multi-cassette circuit breaker arrangements encompassing both three-pole and four-pole configurations, it is desirable to have a common mechanism that is capable of driving a four-pole arrangement, while not exerting excessive load on the components of a three-pole arrangement.

It would therefore be beneficial to provide a reliable and inexpensive clamping arrangement that eliminates the relative movement between the connecting rods and speeds the movement of the rotor in the outer cassette of an asymmetrically positioned four-pole molded case rotary circuit breaker, while at the same time providing a contact depression arrangement that is not uniform across all four poles for effective toggling of the operating mechanism on closure.

### SUMMARY OF INVENTION

In an exemplary embodiment of the invention, movement of contacts within individual cassettes of a multi-pole circuit breaker, occasioned by a trip event or operation of the operating mechanism thereof, is reliably and inexpensively effected by the addition of a clamp upon the connecting rods (drive rod and support rod) of the breaker, for example, between the third and fourth cassettes of the breaker. Clearance between the connecting rods and the rotor of the fourth cassette, and the absence of the same clearance in the first, second and third cassettes, produces reduced contact depression in the fourth pole, the neutral pole, and a staggered load on the operating mechanism during closure, thereby providing a three-pole operating mechanism with the ability to efficiently toggle a four-pole circuit breaker arrangement.

The reduced contact depression in the fourth pole is chosen to be of sufficient value to meet the desired design performance for the device as a whole. A reduced electrical duty on the fourth pole, as compared to the other poles that carry primary current, provides the design option of reducing the contact depression in the fourth pole without a reduction in overall device performance. For example, in a theoretically balanced three-phase four-wire system, the first, second and third cassettes of a three-phase circuit breaker carry the primary current with a phase shift of 120-degrees between phases, and the fourth cassette for the neutral circuit carries no current in the neutral leg. However, in a typical application it is not uncommon for the neutral leg of the protected circuit to carry a fraction of the current present in one or more of the primary legs, resulting in the fourth pole cassette having a lesser electrical duty than the first, second or third cassettes. Since the electrical duty is of a lesser degree in the fourth pole as compared to the primary current poles, a lower contact depression may be employed in the fourth pole.

The holding clamp for the connecting rods preferably includes surface features conducive to receiving and arresting the drive rod and the support rod relative to each other. By restricting relative movement between the drive rod and support rod, the outer cassette is provided with as much impetus to move due to actuation of the operating mechanism or a trip event as are the first or third cassettes, being immediately adjacent the second cassette upon which the operating mechanism is mounted. However, by allowing a degree of relative movement between the connecting rods and the rotor of the fourth cassette, the fourth cassette, now having a lower contact depression, will move with as much speed as the other cassettes, but with less toggling load on the operating mechanism.

The clamp may be of a single piece of material such as metal or plastic with material removed therefrom to receive the rods, or may be of more than one piece wherein the separate pieces are attachable by various means with the desired result being that relative movement between the rods is minimized.

### BRIEF DESCRIPTION OF DRAWINGS

The present invention will now be described, by way of example, with reference to the accompanying drawings in which:

FIG. 1 is a front perspective view of an electrical distribution panel;

FIG. 2 is a front perspective view of a three-pole molded case circuit breaker;

FIG. 3 is a front perspective view of the three-pole molded case circuit breaker of FIG. 2 with the cover removed;

FIG. 4 is a side section view of a cassette of the molded case circuit breaker of FIG. 2 showing the internal components of the cassette;

FIG. 5 is a perspective exploded view of a four-pole molded case circuit breaker similar to the three-pole circuit breaker of FIG. 2;

FIG. 6 is a perspective exploded view of the stabilizer clamp and the drive rod and the support rod;

FIG. 7 is a perspective view of stabilizer clamp assembled on the drive rod and the support rod;

FIG. 8 is a perspective exploded view of an alternate embodiment of the clamp of FIG. 6; and

FIG. 9 is a perspective view of the alternate clamp of FIG. 8 assembled on the drive rod and the support rod.

### DETAILED DESCRIPTION

Distribution Panel Generally

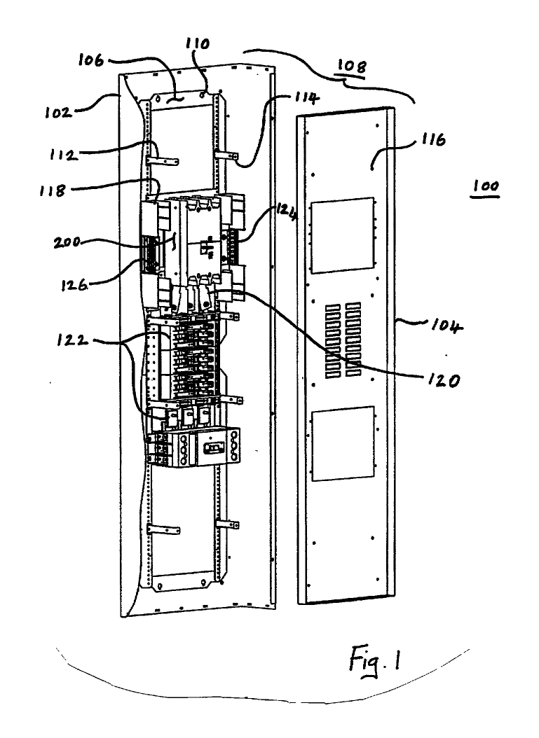

A three phase electrical distribution panel is depicted generally in FIG. 1, is fully described in commonly assigned U.S. patent application Ser. No. 09/560,226 entitled “Electrical Distribution Panel With Split Neutral Bus” filed Apr. 28, 2000, functions generally to distribute protected power from a common main source to a plurality of branch circuits, and is described generally below.

Referring to FIG. 1, a three phase electrical distribution panel 100 includes a panel base 102, a panel cover 104 and an interior assembly 106. The panel base 102 and panel cover 104 generally make up the panel housing 108 of distribution panel 100. The interior assembly 106 is attached to panel base 102 by suitable fasteners, not shown, through mounting holes 110. Upstanding supports 112 are integral to interior assembly 106 and provide attachment surfaces 114 for attachment of panel cover 104, which is secured to the attachment surfaces 114 by suitable fasteners, not shown, through holes 116 in panel cover 104.

Interior assembly 106 includes main support 118 for mechanically supporting a main circuit device, such as but not limited to a circuit breaker 200 that is fully described below, at least one busbar 120 for connecting circuit breaker 200 to a plurality of branch circuit connections 122, a ground connector 124 for providing an electrical ground connection within the distribution panel 100, and a neutral connector 126 for providing an electrical neutral connection within the distribution panel 100. Power distribution to a plurality of branch circuits, not shown, is made through the plurality of branch circuit connections 122.

Circuit Breaker Generally

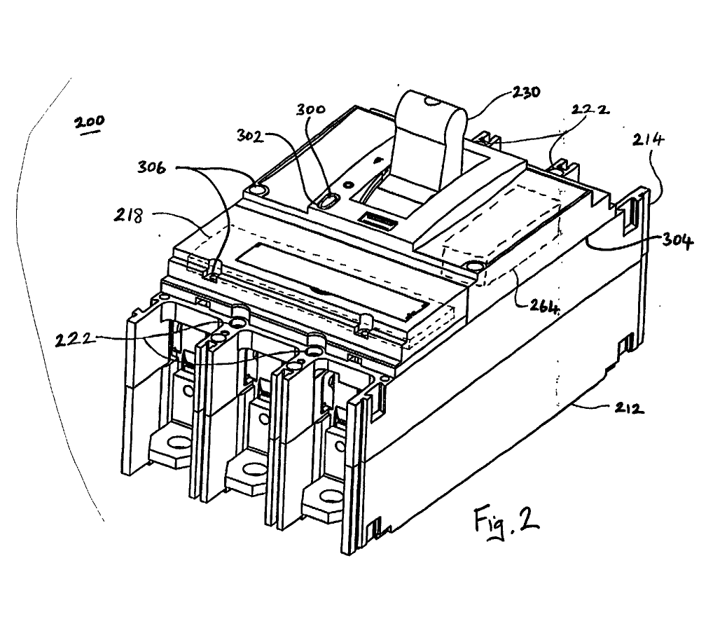

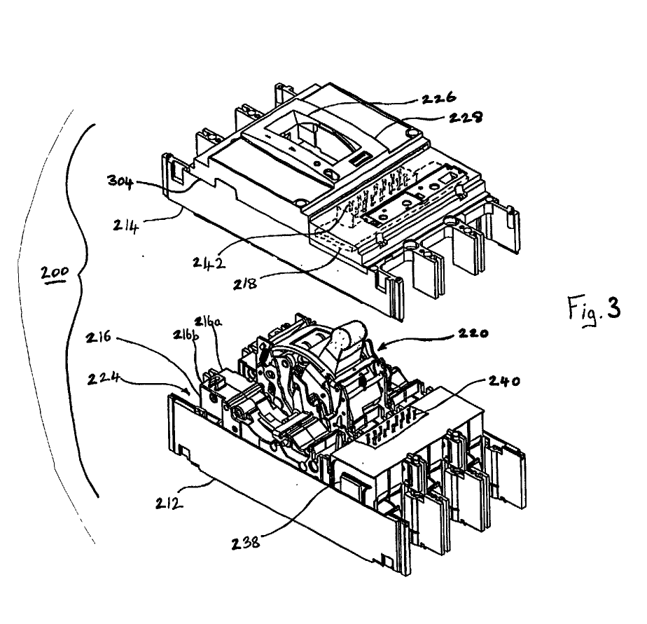

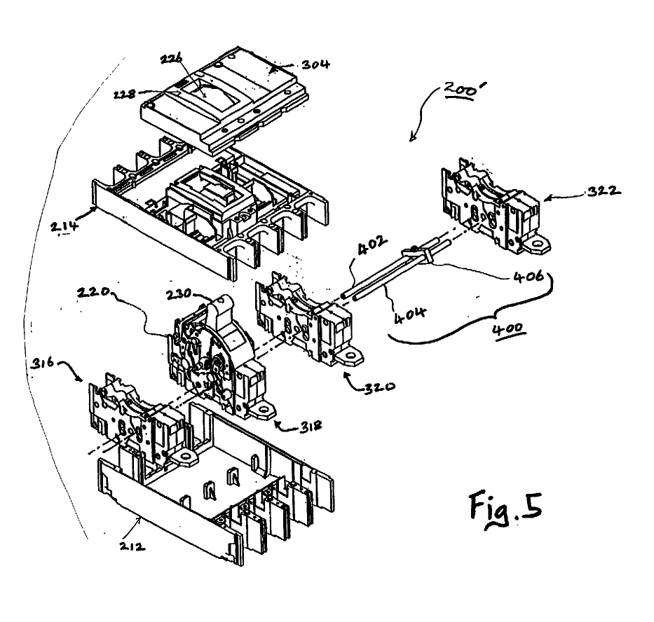

A three-pole circuit breaker 200 is depicted in the perspective view of FIG. 2 and the exploded view of FIG. 3. While reference is made to a three-pole circuit breaker 200 as depicted in FIGS. 1-3, one skilled in the art will appreciate that this is for general descriptive purposes only and that the four-pole circuit breaker 200′ as depicted in FIG. 5 is more representative of the application of the present invention. Base 212 and midcover 214 captivate cassette 216, trip unit 218 and operating mechanism 220 by fasteners, not shown, through holes 222. For illustrative purposes, cassette 216, shown in FIG. 3, will be referred to in the three-pole context, and cassettes 316, 318, 320, 322, shown in FIG. 5, will be referred to in the four-pole context. However, one skilled in the art will appreciate that a three-pole cassette is interchangeable with a four-pole cassette. Cassette halves 216a,b are secured by fasteners, not shown, and are positionally located in pocket 224 of base 212. Pushbutton 300 extends through opening 302 of top cover 304 and is described in more detail below. Top cover 304 is secured to midcover 214 by fasteners, not shown, through holes 306.

For simplicity and clarity, where more than one element of the same type is present, only one will be referenced, but the reader will readily recognize that the single reference pertains to more than one element of the same type. Here, for example, there are three cassettes 216 and three pockets 224. Each cassette 216 is positionally located in an associated pocket 224. Reference is made to a cassette 216 and a pocket 224, but the reader will readily recognize that three cassettes 216 and three pockets 224 are present. Also for simplicity and clarity, reference will only be made to a three phase circuit breaker, but the reader will recognize that the present invention is equally applicable to single phase, two phase or multi-phase electrical switching devices of any kind.

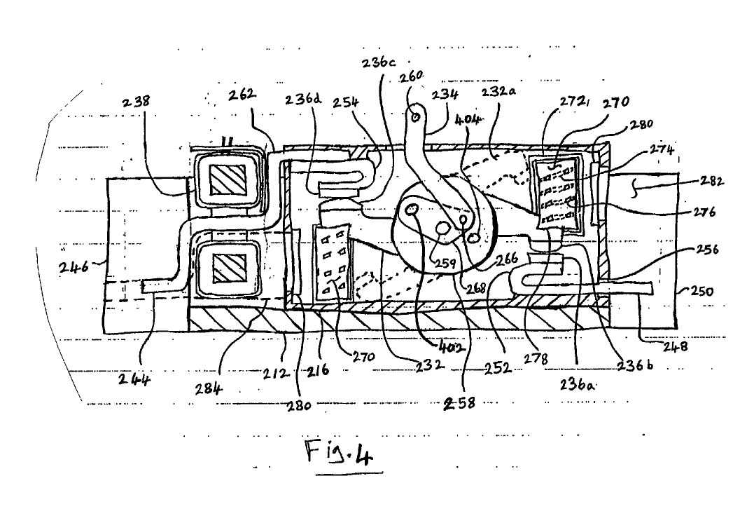

Extending through opening 226 of escutcheon 228 on topcover 304 is operating handle 230, which is operatively connected to movable contact arm 232 by operating mechanism 220 and link 234, best seen by referring to FIG. 4. Handle 230 enables the opening and closing of electrical contacts 236a,b,c,d, best seen by referring to FIG. 4.

An example of operating mechanism 220 is depicted generally in FIG. 3, is fully described in commonly assigned U.S. patent application Ser. No. 09/516,475 entitled “Circuit Interrupter Operating Mechanism” filed Mar. 1, 2000, and functions generally to open and close electrical contacts 236a,b,c,d by actuation of operating handle 230.

Trip unit 218 is of a type that is depicted generally in FIGS. 2 and 3. An example of such a trip unit is fully described in commonly assigned U.S. Pat. Nos. 4,589,052, 4,728,914, and 4,833,563, and functions generally to initiate a trip action within the actuator 264 after receiving a trip signal from current sensors 238.

Trip unit 218 is operatively connected to current sensors 238 by pins 240 and sockets 242, and to operating mechanism 220 by actuator 264, shown in phantom in FIG. 2, to effectuate the opening of contacts 236a,b,c,d upon the occurrence of an abnormal overcurrent condition.

An example of an actuator 264 is shown generally in phantom in FIG. 2, is fully described in commonly assigned U.S. patent application Ser. No. 09/518,899 entitled “Fast Acting High Force Trip Actuator” filed Mar. 6, 2000, and functions generally to transfer the trip action to the operating mechanism 220 after receiving a trip signal from the trip unit 218.

Current sensor 238 is shown generally in FIGS. 3 and 4. A representative example of such a current sensor 238 is fully described in commonly assigned U.S. Pat. Nos. 4,589,052, 4,728,914, and 4,833,563, and functions generally to power up trip unit 218 and provide trip unit 218 with a signal representative of the circuit current in the protected circuit.

Referring to FIG. 4, which depicts a cutaway side view of cassette 216 and current sensor 238 in base 212, electrical connections between the protected circuit, not shown, and circuit breaker 200 are made through load terminal 244 on load side 246 of circuit breaker 200. Electrical connections between the power source, not shown, and circuit breaker 200 are made through line terminal 248 on line side 250 of circuit breaker 200.

Referring to FIGS. 2, 3 and 4, circuit breaker 200 includes operating handle 230 for driving operating mechanism 220 to manually open and close electrical contacts 236a,b,c,d. Contact 236a is carried by elongated fixed contact arm 252, contacts 236b,c are carried by elongated movable contact arm 232, and contact 236d is carried by elongated fixed contact arm 254. FIG. 4 also shows movable contact arm 232a, depicted in phantom, following an opening action by trip unit 218 and operating mechanism 220. Fixed contact arm 252 extends through opening 256 of cassette 216 to terminate in line terminal 248, which is accessible through an opening, not shown, in line side 250 of base 212. Obviously, each phase of the multi-phase circuit breaker would have separate conductors per phase, not shown. Operating mechanism 220 is operatively connected to contact arm 232 by connecting pin 260, link 234, bell crank pin 266, bell crank 268, drive rod 402, rotor 258, and rotor pivot 259. Connecting pin 260 connects link 234 to operating mechanism 220, bell crank pin 266 connects link 234 to bell crank 268, drive rod 402 connects bell crank 268 to rotor 258, and bell crank 268 operatively pivots about rotor pivot 259.

The current path through circuit breaker 200 in the closed position is best seen by referring to FIG. 4. Under quiescent operating conditions, the current from the power source enters circuit breaker 200 through line terminal 248 (and other line terminals on adjacent phases not shown), and exits through load terminal 244 (and other load terminals on adjacent phases not shown). Between line terminal 248, and load terminal 244, the current path consists of; fixed contact arm 252, electrical contacts 236a and b, movable contact arm 232, electrical contacts 236c and d, fixed contact arm 254, and sensor strap 262. Sensor strap 262 passes through and provides primary current signal to current sensor 238, which is operatively connected to trip unit 218 by pins 240 and sockets 242. Fixed contact arm 254 is mechanically and electrically connected to sensor strap 262 by a fastener, not shown. Sensor strap 262 passes through current sensor 238 to terminate in load terminal 244, which is accessible through an opening, not shown, in load side 246 of base 212.

Arc chute, or arc extinguishing assembly 270, is removably captivated within cassette 216 by molded detail 272 that is integral to cassette 216. Arc plates 274, are typically, but not necessarily, arranged substantially parallel to one another, have tabs 276 that are captivated in corresponding slots in plate supports 278. Exhaust baffle 280 is removably captivated within cassette 216 by molded slot, not shown, that is integral to cassette 216. Holes in exhaust baffle 280, not shown, provide for the passage of arc effluent generated from a short circuit interruption condition. The arc effluent passing through exhaust baffle 280 on line side 250 of circuit breaker 200 will exit base 212 through terminal chamber 282. The arc effluent passing through exhaust baffle 280 on load side 246 of circuit breaker 200 will exit base 212 through vent channel 284, shown in phantom in FIG. 4.

Vent channels 284 are shown generally in phantom in FIG. 4, are fully described in commonly assigned U.S. patent application Ser. No. 09/366,473 entitled “Bottom Vented Circuit Breaker Capable of Top Down Assembly Onto Equipment” filed Aug. 3, 1999, and function generally to provide a passage for the arc effluent to travel from the inside of cassette 216 to the outside of circuit breaker 200 during an abnormal overcurrent condition.

Drive Rod Assembly

FIG. 5 depicts several subassemblies of the circuit breaker of FIG. 2 in an exploded perspective view. First, second, third and fourth cassettes 316, 318, 320 and 322 are depicted in an exploded assembly arrangement with operating mechanism 220 arranged on second cassette 318, and with drive rod assembly 400 shown between third and fourth cassettes 320 and 322. First and fourth cassettes 316, 322 are generally known as outboard cassettes, and second and third cassettes 318, 320 are generally known as inboard cassettes.

The rotor and movable contact arm within the first cassette 316, on one side of the operating mechanism 220, and the rotor and movable contact arm within the third and fourth cassettes 320 and 322, on the opposite side of the operating mechanism 220, are coupled together with the drive rod 402 and the support rod 404, and move in unison under the action of the operating mechanism 220 thereby providing a complete multi-pole circuit interruption.

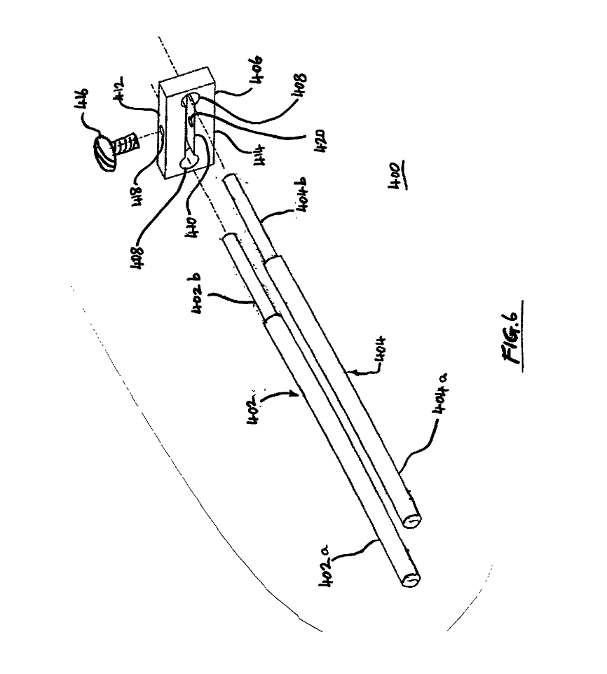

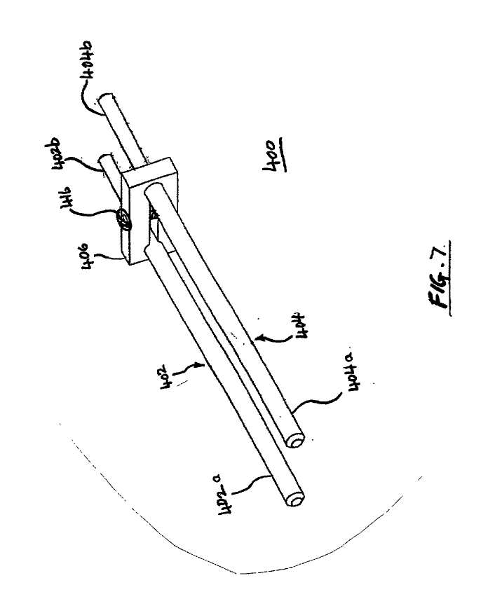

In the case of an asymmetrical arrangement of cassettes, that is, where there are more cassettes on one side of the operating mechanism than the other, the farther the drive rod 402 and support rod 404 extend from the operating mechanism 220, the more relative movement there will be between the two rods. In a four-pole molded case circuit breaker, the relative movement between the drive rod 402 and the support rod 404 connecting to the fourth cassette causes a torque loss from the operating mechanism 220 to the movable contact arm in the fourth cassette 322. A stabilizer clamp 406 reduces the relative movement between the drive rod 402 and the support rod 404 and thereby allows the rods to deliver maximum torque to the movable contact arm of the fourth cassette 322. To provide for effective toggling of the operating mechanism 220 on closure, clearance is provided between the drive and support rods 402, 404, and the rotor of the fourth cassette 322. Since it is desirable to have one cassette construction for each of the four cassettes in a four-pole circuit breaker, the clearance is best provided by the construction of the drive and support rods 402,404, as is best seen by now referring to FIGS. 6 and 7.

Drive Rod and Support Rod

Referring to FIGS. 6 and 7, a drive rod 402, support rod 404 and stabilizer clamp 406 are illustrated apart from other components of the circuit breaker. First ends 402a, 404a of drive and support rods 402,404, have a larger dimension, or cross-sectional area, than second ends 402b, 404b. The first ends 402a, 404a, are arranged to couple with the first, second and third cassettes 316, 318, 320, and the second ends 402b, 404b, are arranged to couple with the fourth cassette 322. Since the openings in the rotor 258, shown generally at 402, 404 in FIG. 4, are preferably the same across all four poles, the smaller dimension of second ends 402b, 404b, will result in a clearance condition between drive and support rods 402, 404, and the rotor of the fourth cassette 322, thereby resulting in a loosely coupled arrangement between rods 402, 404 and the fourth cassette 322. The staggered contact depression resulting from this loosely coupled arrangement will thereby enable effective toggling of the operating mechanism on closure.

One embodiment of the stabilizer clamp 406 is preferably constructed from a single piece of material. The material may be of any type capable of providing stability to the two rods. Preferred materials include but are not limited to metal and plastic. Openings 408 formed in clamp 406 are dimensioned to conform to the shape of second ends 402b, 404b of drive and support rods 402, 404. However, one skilled in the art will also appreciate that openings 408 may alternatively be dimensioned to conform to the shape of first ends 402a, 404a of drive and support rods 402, 404. The choice of which end of drive and support rods 402, 404 the openings 408 conform to is a matter of design choice, provided that the desired effect of a staggered contact depression is achieved.

With the clamp 406 positioned within the circuit breaker, drive rod 402 is positioned through opening 408, and support rod 404 is positioned through the other opening 408. It is preferable that the rods be affixed in the desired position to the clamp, which can be effected in several ways. A preferred arrangement for affixing the clamp is to provide the stabilizer clamp 406 with a slot 410 extending from one opening 408 to the other opening 408. The slot 410 and openings 408 result in bifurcating a top portion 412 and a bottom portion 414 of clamp 406, which allows for some resilient movement between the top portion 412 and the bottom portion 414. By urging top portion 412 toward bottom portion 414, openings 408 are affected. The affect is to reduce the dimension measured from top portion 412 to bottom portion 414. Reducing this dimension in each of the openings 408 causes the rods to be pinched by the clamp within each opening. The pinching action, when orchestrated to a sufficient degree, will reliably retain the rods and reduce relative movement therebetween. However, since second ends 402b, 404b have a smaller dimension than first ends 402a, 404a of drive and support rods 402, 404, the reduced relative movement between the rods will not negatively impact the desired staggered contact depression between the fourth pole and the other three poles.

With respect to urging top portion 412 and bottom portion 414 toward one another, one preferred tightening means is a screw 416. Alternate tightening means include, but are not limited to, a thread-forming screw, a nut and bolt, and a rivet. In an embodiment where a screw is used, the screw is passed through the top portion 412 via a clearance opening 418 and threaded into the bottom portion 414 via a threaded opening 420. Tightening the screw 416 urges the top portion 412 and the bottom portion 414 together and allows the openings to embrace the rods tightly as stated above, thereby locking them together. FIG. 7 illustrates a drive rod assembly 400 where stabilizer clamp 406 is mounted on drive and support rods 402, 404, using screw 416 to securely lock the rods together.

Alternative Embodiment for Drive Rod Assembly

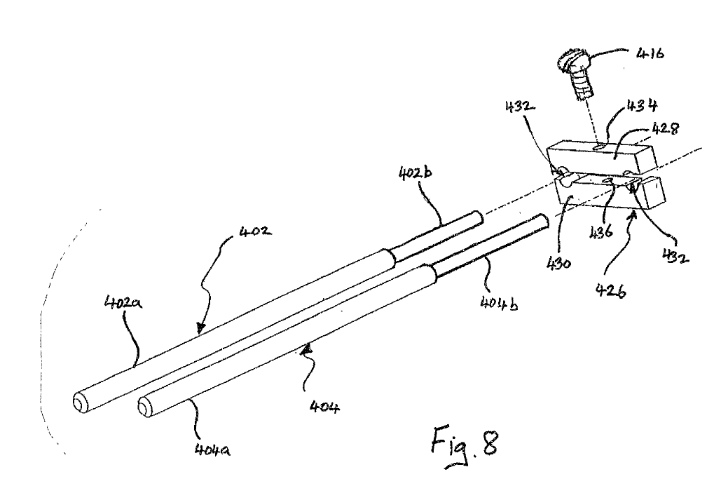

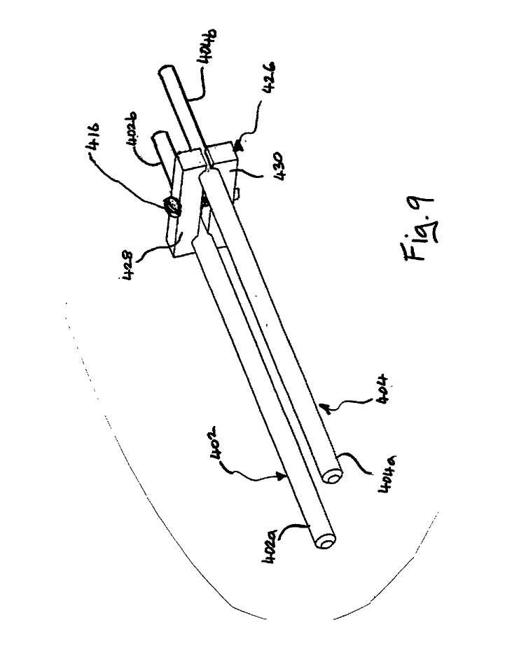

FIGS. 8 and 9 illustrate an exploded and assembled view, respectively, of an alternate drive rod assembly of the invention. In FIGS. 8 and 9, like numerals have been employed for like elements discussed in connection with FIGS. 6 and 7. Elements of FIGS. 8 and 9 that are similar to elements of FIGS. 6 and 7 but not identical thereto are discussed briefly below. However, one of ordinary skill in the art will clearly understand the alternative embodiment from a review of the drawings and reference to the foregoing discussion.

Stabilizer clamp 426 includes upper portion 428 and lower portion 430 with segmented openings 432. Clearance opening 434 and threaded opening 436 accept the screw 416 as discussed above to securely tighten the upper and lower portions of the stabilizer clamp and lock the rods together.

Additional Alternative Embodiment for Drive Rod Assembly

The aforementioned drive rod assembly 400 and fourth pole cassette 322 are coupled together by second ends 402b, 404b of drive and support rods 402, 404 engaging rotor openings, generally depicted at 402, 404 in FIG. 4, of rotor 258. In the aforementioned embodiment, it was considered desirable to use a standard construction rotor 258 across all three poles, wherein the rotor openings for accepting drive and support rods 402, 404 were sized to accept both first and second ends 402a, 402b, 404a, 404b of drive and support rods 402, 404. As described above, use of a smaller dimension for second ends 402b, 404b than for first ends 402a, 404a, resulted in a loosely coupled arrangement between drive rod assembly 400 and fourth cassette 322.

Alternatively, a loosely coupled arrangement between drive rod assembly 400 and fourth cassette 322 may be achieved by using drive and support rods 402, 404 where first and second ends 402a, 404a, 402b, 404b are of the same size, but where the rod-accepting openings in the fourth pole rotor in the fourth cassette 322 are larger in size than the respective openings in the first, second and third cassettes 316, 318, 320.

Thus, a loosely coupled arrangement between drive rod assembly 400 and fourth cassette 322 may be achieved by using a standard cassette arrangement for all four cassettes and a drive rod assembly with dissimilar rod end dimensions, or by using a non-standard cassette arrangement for the fourth cassette and a drive rod assembly with similar rod end dimensions.

Operation of Invention Generally

Under quiescent operating conditions with the circuit breaker 200 in the closed state, drive and support rods 402, 404 interact with rotor 258 to hold contacts 236a,b,c,d in the closed position under the influence of the operating mechanism 220. As described previously, first ends 402a, 404a of drive and support rods 402, 404 are arranged to couple with the first, second and third cassettes 316, 318, 320, and second ends 402b, 404b are arranged to couple with the fourth cassette 322, thereby providing a fourth pole arrangement with slightly less contact depression than the other three poles, but with sufficient contact depression for the desired performance of the circuit breaker as a whole.

Under a dynamic closing condition, drive and support rods 402, 404 urge movable contact arm 232 in each of the four cassettes 316, 318, 320, 322 toward the closed position. Since first ends 402a, 404a of drive and support rods 402, 404 have a larger dimension than second ends 402b, 404b, the contacts 236a,b,c,d in the first, second and third cassettes 316, 318, 320 will make contact before the contacts in the fourth cassette, thereby resulting in a staggered load as seen by the operating mechanism 220. Completion of the closing action results in a fully toggled operating mechanism and all four poles being at their respective full contact depression.

While this invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A connecting rod arrangement for a multi-pole circuit protective device, comprising:
a first and second rod having first and second ends;
a clamp having a plurality of openings for accepting said rods;
a tightening means for securing said clamp to said rods; and
a means for coupling said rods to a multi-pole circuit protective device wherein said second ends are loosely coupled with one pole of the multi-pole circuit protective device.

2. The connecting rod arrangement of claim 1, wherein said first ends have a larger dimension than said second ends.

3. The connecting rod arrangement of claim 1, whereinsaid clamp is constructed of a material selected from the group consisting of metal and plastic.

4. The connecting rod arrangement of claim 1 wherein said tightening means is a screw.

5. The connecting rod arrangement of claim 1 wherein said first ends extend further from said clamp than said second ends.

6. A multi-pole circuit breaker comprising:
a base;
a cover mounted on said base and defining an interior space
a plurality of cassettes mounted within said interior space;
an operating mechanism operably coupled to at least one of said cassettes for opening and closing said cassettes;
a connecting rod arrangement operably connecting said cassettes to one another; and
wherein said connecting rod arrangement is loosely coupled to at least one of said cassettes

7. The multi-pole circuit breaker of claim 6, wherein;
said plurality of cassettes comprises four cassettes arranged sequentially;
wherein said operating mechanism is operably coupled to one of the two inboard cassettes; and
wherein said connecting rod arrangement is loosely coupled to one of the two outboard cassettes.

8. The multi-pole circuit breaker of claim 6, wherein said connecting rod arrangement comprises:
a first and second rod having first and second ends;
wherein said first ends have a larger dimension than said second ends;
a clamp having a plurality of openings for accepting said rods;
a tightening means for securing said clamp to said rods; and
wherein said first ends extend further from said clamp than said second ends.

9. An electrical distribution panel, comprising:
a panel base;
a panel cover coupled to said panel base and defining a panel interior therein;
a multi-pole circuit breaker within said panel interior;
a plurality of branch circuit connections within said panel interior;
at least one busbar for electrically connecting said circuit breaker to said plurality of branch circuit connections;
wherein said circuit breaker comprises:
a base;
a cover mounted on said base and defining an interior space;
a plurality of cassettes mounted within said interior space;
an operating mechanism operably coupled to at least one of said cassettes for opening and closing said cassettes;
a connecting rod arrangement operably connecting said cassettes to one another; and
wherein said connecting rod arrangement is loosely coupled to at least one of said cassettes.

10. A method of assembling a connecting rod arrangement, comprising the steps of;
selecting a first rod having a first end dimension that is larger than the opposite end dimension;
selecting a second rod having a first end dimension that is larger than the opposite end dimension;
selecting a clamp having a plurality of openings for accepting said rods;
inserting said rods into said plurality of openings of said clamp; and securing said clamp to said rods.

11. A multi-pole circuit breaker comprising;
a plurality of cassettes;
a means for coupling said plurality of cassettes; wherein
said coupling means further comprises a means for loosely coupling one of said cassettes.
